(19) United States
(12) Patent Application Publication
(10) Pub. No.: US 2026/0141212 A1
(43) Pub. Date: May 21, 2026

(54) AUTONOMOUS SEMANTIC DIFFERENTIATION USING MACHINE LEARNING

(71) Applicant: INTERNATIONAL BUSINESS MACHINES CORPORATION, ARMONK, NY (US)

(72) Inventors: GENNARO ANTHONY CUOMO, RALEIGH, NC (US); HAECHUL SHIN, DURHAM, NC (US); ZHONG FANG YUAN, XIAN (CN); LUCIA LARISE STAVARACHE, COLUMBUS, OH (US); TONG LIU, XIAN (CN)

(21) Appl. No.: 18/952,315

(22) Filed: Nov. 19, 2024

(51) Int. Cl. G06N 3/042

(52) U.S. Cl. CPC G06N 3/042

(57) ABSTRACT

Autonomous semantic differentiation using machine learning, including: generating a semantic hyperspace comprising a plurality of microagents each corresponding to a service accessible to a large language model (LLM), wherein each microagent is located in the semantic hyperspace based on a description of the corresponding service; identifying one or more groups of microagents each comprising a plurality of semantically proximate microagents; and generating an updated semantic hyperspace by updating, for each of the one or more groups of microagents, the description of the corresponding service for one or more of the semantically proximate microagents using the LLM and based on inter-group communication between the plurality of semantically proximate microagents.

### BACKGROUND

The present disclosure relates to methods, apparatus, and products for autonomous semantic differentiation using machine learning.

### SUMMARY

According to embodiments of the present disclosure, various methods, systems and products for autonomous semantic differentiation using machine learning are described herein. In some aspects, autonomous semantic differentiation using machine learning includes generating a semantic hyperspace comprising a plurality of microagents each corresponding to a service accessible to a large language model (LLM), wherein each microagent is located in the semantic hyperspace based on a description of the corresponding service; identifying one or more groups of microagents each comprising a plurality of semantically proximate microagents; and generating an updated semantic hyperspace by updating, for each of the one or more groups of microagents, the description of the corresponding service for one or more of the semantically proximate microagents using the LLM and based on inter-group communication between the plurality of semantically proximate microagents. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a block diagram of an example computing environment for autonomous semantic differentiation using machine learning in accordance with some embodiments of the present disclosure.

FIG. 2 sets forth an example diagram of an agent accessing semantically conflicting services in accordance with some embodiments of the present disclosure.

FIG. 3 sets forth an example diagram of agent semantic conflict in accordance with some embodiments of the present disclosure.

FIG. 4 sets forth a visual representation of agent semantic differentiation in accordance with some embodiments of the present disclosure.

FIG. 5 sets forth an example flow diagram of autonomous semantic differentiation using machine learning in accordance with some embodiments of the present disclosure.

FIG. 6A sets forth an example diagram of clustering services for autonomous semantic differentiation using machine learning in accordance with some embodiments of the present disclosure.

FIG. 6B sets forth a flow diagram for updating a microagent descriptions for autonomous semantic differentiation using machine learning in accordance with some embodiments of the present disclosure.

FIG. 7 sets forth a flowchart of an example method of autonomous semantic differentiation using machine learning in accordance with some embodiments of the present disclosure.

FIG. 8 sets forth a flowchart of another example method of autonomous semantic differentiation using machine learning in accordance with some embodiments of the present disclosure.

FIG. 9 sets forth a flowchart of another example method of autonomous semantic differentiation using machine learning in accordance with some embodiments of the present disclosure.

FIG. 10 sets forth a flowchart of another example method of autonomous semantic differentiation using machine learning in accordance with some embodiments of the present disclosure.

FIG. 11 sets forth a flowchart of another example method of autonomous semantic differentiation using machine learning in accordance with some embodiments of the present disclosure.

### DETAILED DESCRIPTION

Generative artificial intelligence (AI) models such as large language models (LLMs) may access external services to facilitate processing requests. In order to select a particular service to use, the LLM analyzes the code and descriptions of the service and selects a service semantically relevant to a received request. Where different services have semantically similar descriptions, despite performing different functions, the LLM may select the incorrect service for a particular task. This may be due, for example, due to the descriptions of different services being written independently by different persons. This faulty selection of services, called agent semantic confusion, may lead to incorrect or irrelevant results produced by the LLM.

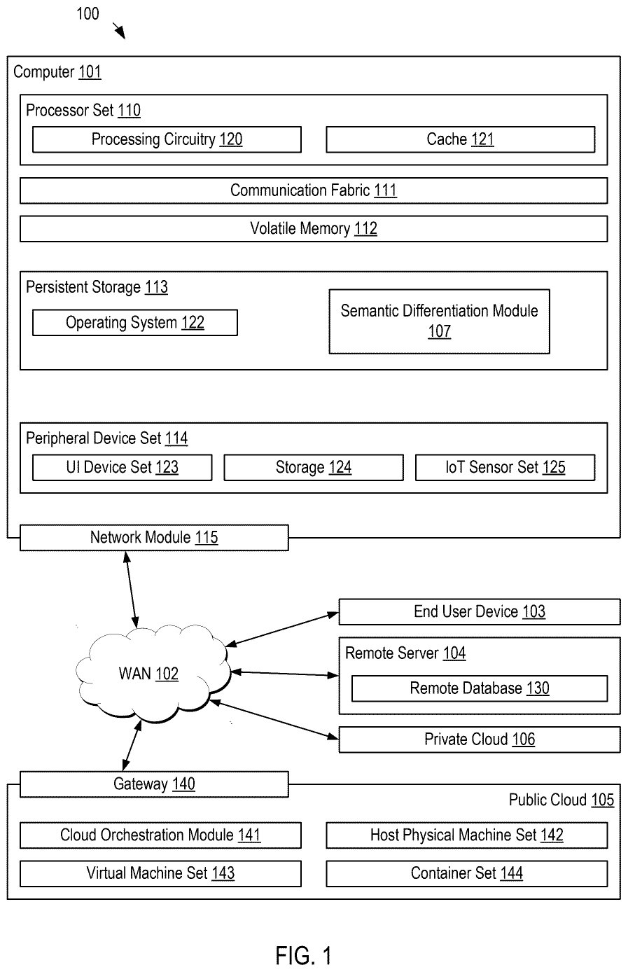

With reference now to FIG. 1, shown is an example computing environment according to aspects of the present disclosure. Computing environment 100 contains an example of an environment for the execution of at least some of the computer code involved in performing the various methods described herein, such as the semantic differentiation module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

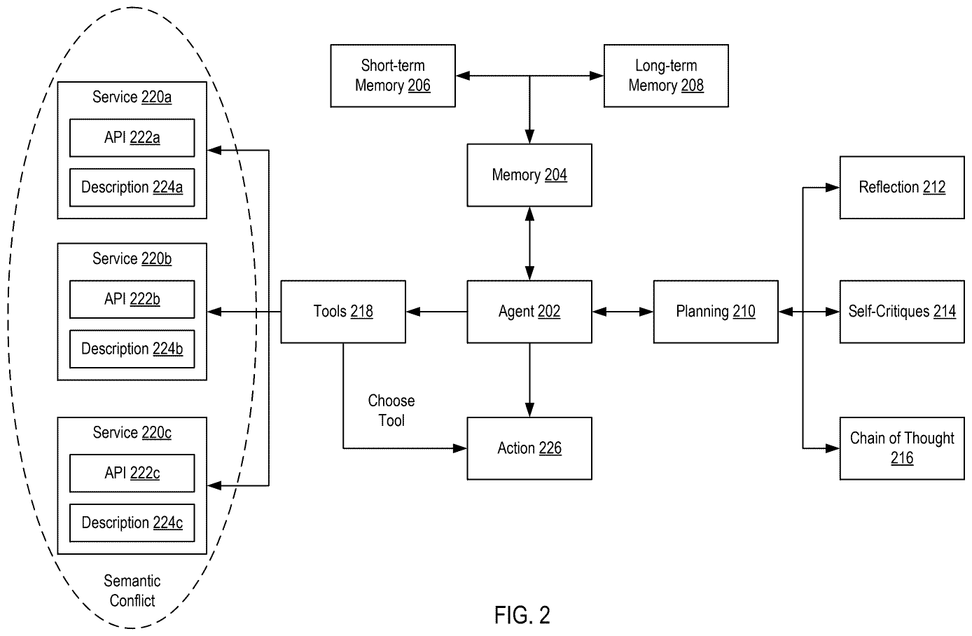

FIG. 2 sets forth a diagram of an agent 202 accessing semantically conflicting services in accordance with some embodiments of the present disclosure. The agent 202 may include a process or service accessible to a large language model (LLM) or potentially an LLM itself that may process natural language requests (e.g., prompts). Although the following discussions are presented in the context of a LLM, readers will appreciate that the approaches set forth herein may also be applied to any generative artificial intelligence (AI) or other model trained to process natural language inputs.

To process natural language request, the agent 202 may access a memory 204 including both short-term memory 206 and long-term memory 208. Both the short-term memory 206 and long-term memory 208 store contextual information and knowledge that may be usable in processing requests. For example, the short-term memory 206 may store information related to recent prompts or other interactions to provide context in processing requests. As another example, the long-term memory 208 may store a knowledge base of information for processing requests.

The agent 202 may also implement various planning 210 modules to facilitate processing requests and improving the quality of results. For example, reflection 212 and self-critiques 214 may allow for reviewing and evaluating past performance to prevent hallucinations or other faulty responses. As another example, the chain of thought 216 provides a step-by-step reasoning in how a particular result was generated, allowing for analysis as to how the result came about.

The agent 202 also has access to multiple tools 218 to assist in processing requests. Where the agent 202 or LLM is unable to solely process some request, these external tools 218 (e.g., services) may be called to facilitate processing some request. Readers will appreciate that tools 218 and “services” may be hereinafter referred to interchangeably as the collection of tools 218 includes multiple services 220a, b, c. Each service 220a, b, c may include its own application program interface (API) 222a, b, c that may be called in order to use the corresponding service 220a, b, c. Each service 220a, b, c may also include a description 224a, b, c that includes a natural language description or commentary on the corresponding service 220a, b, c. In order to select a particular tool 218 for use by the agent 202, the API 222a, b, c code and descriptions 224a, b, c are analyzed. A particular tool 218 may then be selected based on semantic considerations. The selected tool 218 will then be used by the agent 202 to perform some action 226.

Selecting a particular tool 218 using semantic considerations presents a potential drawback where the descriptions 224a, b, c may be semantically close. This may be due to the fact that these descriptions 224a, b, c may be written independently by different persons based on their own perceptions. Accordingly, it may be possible for the agent 202 to select the wrong tool 218 or a less appropriate tool 218 for performing some action 226. This situation is hereinafter referred to as “agent semantic conflict.”

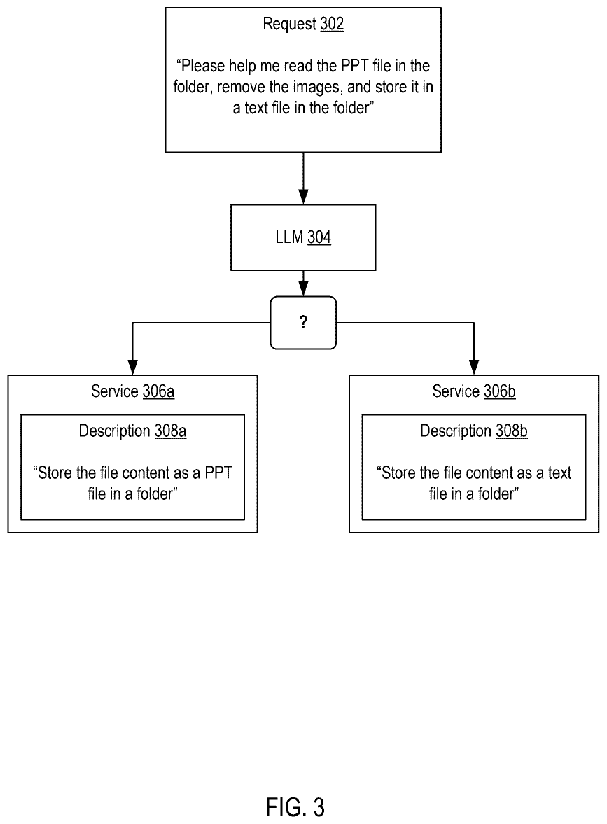

To further illustrate this, FIG. 3 sets forth a diagram of agent semantic conflict in accordance with some embodiments of the present disclosure. Here, a request 302 has been provided to an LLM 304 requesting that the LLM 304 open a PowerPoint (PPT) file in a folder, remove the included images, and store the remaining text into a text file in that folder. The LLM 304 may then select from two services 306a, b to assist in processing this request. Service 306a includes a description 308a that indicates it can store file content as a PPT file while service 306b includes a description 308b indicating that it can store file content as a text file. Here, service 308b would be the correct choice as the request indicates that the opened file content should be saved as a text file. However, the LLM 304 may select the incorrect service 306a due to the description 308a sharing some keywords with the request 302, including “PPT,” “file,” “folder,” and the like.

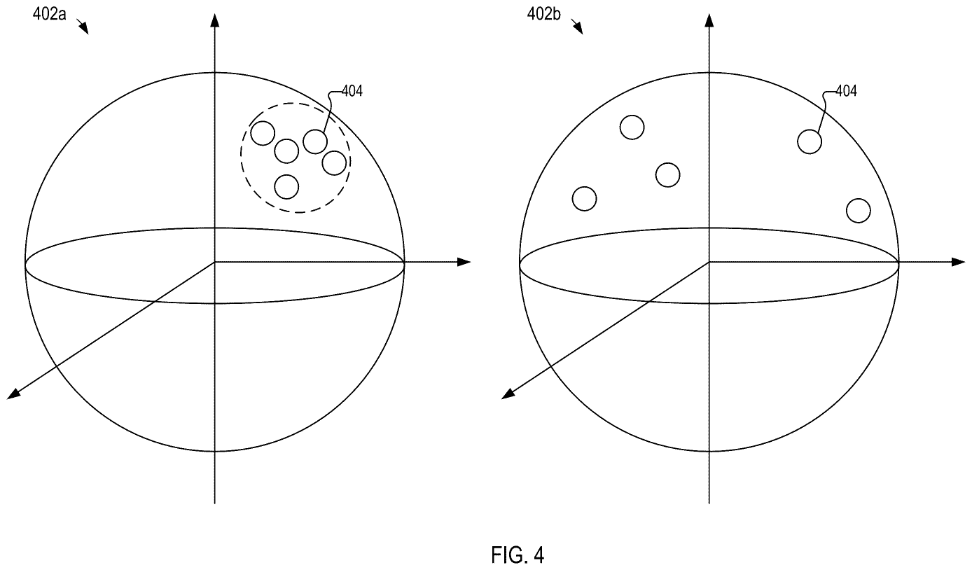

FIG. 4 sets forth a visual representation of performing agent semantic differentiation in accordance with some embodiments of the present disclosure. Particularly, FIG. 4 shows two semantic hyperspaces 402a, b. A semantic hyperspace 402a, b is a multidimensional hyperspace. Some semantic information such as text may be converted into a vector representation corresponding to a point in the semantic hyperspace 402a, b. Although the semantic hyperspaces 402a, b as shown as three-dimensional spaces, readers will appreciate that this is for illustrative purposes and clarity and that, in some embodiments, a semantic hyperspace 402a, b may potentially include any number of multiple dimensions.

Here, each semantic hyperspace 402a, b includes multiple points corresponding to a particular service 404. The description of a service 404 may be converted into a vector representation so as to place the service 404 in a semantic hyperspace 402a, b. Assume that the services 404 were initially placed as shown in the semantic hyperspace 402a. Here, these services 404 are highly proximate relative to each other in the semantic hyperspace 402a. This may be due, for example, to the descriptions of the services 404 being semantically similar to each other. Accordingly, the services 404 as shown in the semantic hyperspace 402a may be highly susceptible to agent semantic confusion. In contrast, after performing agent semantic differentiation, as will be described in further detail below, the descriptions of the services 404 may be iteratively modified until they are less semantically similar. This causes their corresponding points in the semantic hyperspace 402b to be less tightly clustered, making agent semantic confusion less likely to occur. In other words, using their modified descriptions, each service 404 will appear, to an LLM, to be more semantically distinct.

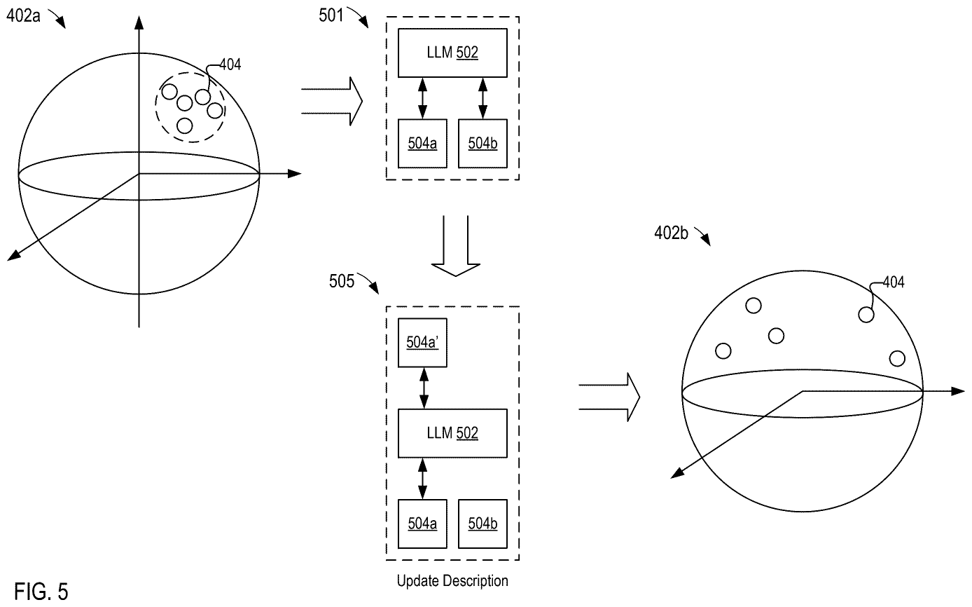

FIG. 5 shows an example flow diagram of autonomous semantic differentiation using machine learning in accordance with some embodiments of the present disclosure. Particularly, FIG. 5 shows a flow diagram of how the semantic hyperspace 402a of FIG. 4 may be modified into the semantic hyperspace 402b of FIG. 4. In the example of FIG. 5, each service 404 may correspond to or be represented by microagent capable of sending messages to and/or reading information from other microagents. Each microagent will navigate through the semantic hyperspace 402a by updating the descriptions of their corresponding services based on their current position and information from other microagents similar to an ant colony algorithm. In other words, in some embodiments, each microagent may correspond to an “ant” in the ant colony algorithm. For example, as will be described in further detail below, each microagent within a particular grouping or clustering of microagents may communicate with each other by virtue of their semantic proximity.

In some embodiments, each microagent may encapsulate various functions that may be performed with respect to itself or other microagents. For example, in some embodiments, each microagent may include an instance of a class in an object-oriented system. In some embodiments, these functions may include a “read_description” function that reads the description of another microagent (e.g., of its corresponding service), a “receive_information” function that allows a given microagent to receive a message from another microagent, a “send_information” function for sending a message to another microagent, an “update_description” function that allows a given microagent to modify its description, and a “self_examination” function that allows a given agent to examine its current (e.g., updated) description. Other functions are also contemplated within the scope of the present disclosure.

In the example of FIG. 5, assume that a single cluster of services 404 has been identified in the semantic hyperspace 402a. At step 501, each microagent may read the descriptions of other microagents (e.g., the descriptions of the corresponding services). For example, a microagent 504a may read the description of a microagent 504b. Readers will appreciate that, although FIG. 5 shows only a pair of microagents 504a, b, this process may be repeated for each possible pair of microagents within a grouping or cluster such that each microagent will read the description of each other microagent within the grouping or cluster.

Having read the descriptions of each other microagent, each microagent may then use the LLM 502 to determine how the descriptions of the microagents should be modified from the perspective of the given microagent. The LLM 502 may be used, for example, to analyze or process the natural language descriptions of the microagents to identify potential semantic conflicts and determine what changes should be made to what descriptions. As an example, each message to or from another microagent may be embodied or encoded as a natural language expression. The LLM 502 may be used, for example, to process or interpret received messages, to generate messages for sending to another microagent, and the like. Each microagent may then send messages to other microagents requesting modifications to particular portions of their descriptions. The LLM 502 may then determine, for a given microagent and based on its received messages, what changes to make to the description of the given microagent. For example, at step 505, the microagent 504a may send a message to the LLM 502 requesting an update of its description to avoid conflict with the microagent 504b. The LLM 502 may then generate an updated description for the microagent 504a, now shown as microagent 504a′. This updated description will also have a different, updated vector representation, thereby relocating the microagent 504a′ within the semantic hyperspace 402a. This process may be repeated for other microagents as can be appreciated. Moreover, this process of exchanging information to determine and apply changes to descriptions as shown in step 501 and step 505 may be repeatedly performed until some termination condition has been satisfied. Once the termination condition has been satisfied, the descriptions of the services 404 may have been updated to a degree such that they are more semantically distributed as shown in the semantic hyperspace 402b.

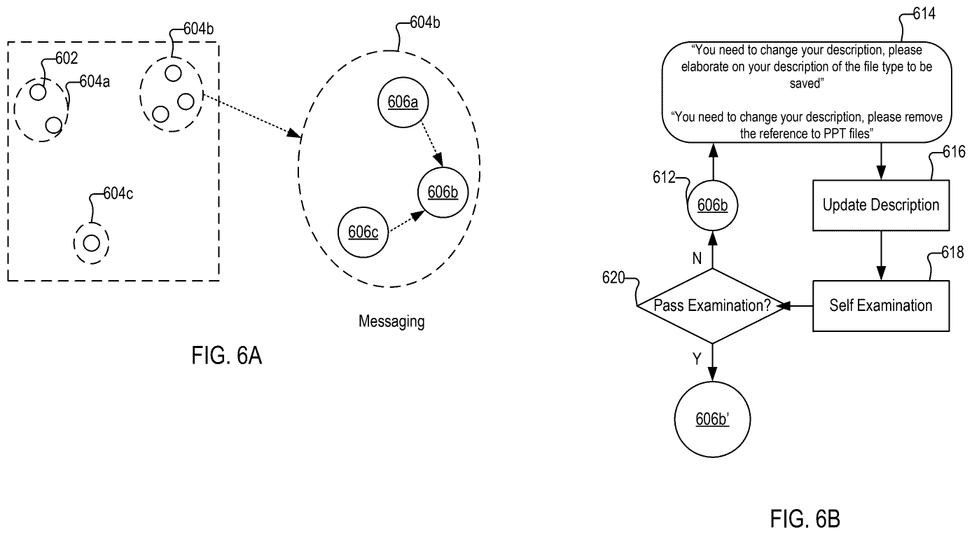

FIG. 6A shows an example diagram of clustering services for autonomous semantic differentiation using machine learning in accordance with some embodiments of the present disclosure. In some embodiments, a semantic hyperspace of services 602 may be clustered prior to any exchange of information between the corresponding microagents. In some embodiments, clustering serves to identify those services 602 deemed to be semantically proximate so as to be at risk of agent semantic confusion. In other words, each service 602 within a given cluster may be deemed to be semantically proximate to each other service 602 in the cluster. Accordingly, the services 602 (e.g., their respective microagents) within a given cluster will perform information exchange and update their descriptions as necessary to avoid agent semantic confusion.

In the example diagram of FIG. 6A, the three clusters 604a, b, c of services 602 have been identified. In some embodiments, identifying these clusters 604a, b, c may include applying a k-nearest neighbors (KNN) or other clustering algorithm as can be appreciated to the vector representations of the services 602 within a semantic hyperspace. Here, cluster 604a includes two services 602, cluster 604b includes three services, and cluster 604c includes a single service 602. Accordingly, agent semantic differentiation may be applied to the clusters 604a, b but may not be necessary for the cluster 604c as there are no semantically proximate services 602 included therein.

For illustrative purposes, cluster 604b is expanded to show microagents 606a, b, c corresponding to the services 602 of cluster 604b. After each microagent 606a, b, c has read the descriptions of each other microagent 606a, b, c, assume that microagent 606a sends a message to microagent 606b requesting that it change its description to elaborate on the file type that it saves. Further assume that microagent 606c sends a message to microagent 606b requesting that it change its description to remove the reference to PPT files.

Turning now to FIG. 6B, shown is a flow diagram for updating a microagent description for autonomous semantic differentiation using machine learning in accordance with some embodiments of the present disclosure. Beginning at step 612, a microagent 606b sends the messages 614 it received from microagents 606a, c to an LLM. The LLM processes these messages 614 and generates an updated description for the microagent 606b. The microagent 606b then updates its description accordingly at step 616. At step 618 the microagent 606b performs a self-examination of its updated description. This may include, for example, querying the LLM with its original and updated descriptions for evaluation. In some embodiments, the updated description may fail examination where it has diverged too far from the original description or has compromised its original intent as determined by the LLM. If, at step 620, the updated description fails to pass examination, the process repeats with new updated descriptions until one passes examination or another termination condition is satisfied. Once the updates description passes examination, the updated description is reflected as microagent 606b′.

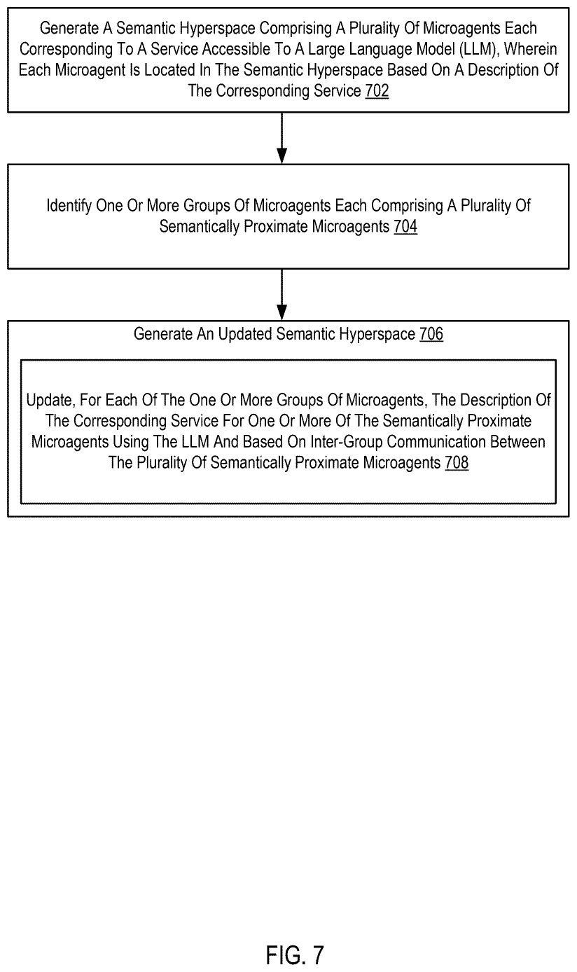

For further explanation, FIG. 7 sets forth a flowchart of an example method of autonomous semantic differentiation using machine learning in accordance with some embodiments of the present disclosure. The method of FIG. 7 may be performed, for example, using the semantic differentiation module 107 of FIG. 1. The method of FIG. 7 includes: generating 702 a semantic hyperspace comprising a plurality of microagents each corresponding to a service accessible to a large language model (LLM), wherein each microagent is located in the semantic hyperspace based on a description of the corresponding service. Each service may include a service that may be accessed by or invoked by the LLM to facilitate processing requests (e.g., prompts) to the LLM. In some embodiments, each service may include an API or other interface accessible to the LLM and a description of the functionality of the service.

As is set forth above, a semantic hyperspace is a multidimensional hyperspace. Semantic information may be included as a point in the semantic hyperspace by converting that semantic information into a vector representation, with the vector representation being a multidimensional point in the semantic hyperspace. Accordingly, in some embodiments, the description of each service may be used to generate a vector representation for that service. A microagent for a given service may then be located in the semantic hyperspace at a point corresponding to its vector representation.

The method of FIG. 7 also includes identifying 704 one or more groups of microagents each comprising a plurality of semantically proximate microagents. In some embodiments, identifying 704 one or more groups of microagents each comprising a plurality of semantically proximate microagents includes applying a clustering algorithm to the semantic hyperspace and the included microagents. Such a clustering algorithm may include a KNN algorithm or other clustering algorithm as can be appreciated. Accordingly, an identified 704 group of microagents may include any cluster that includes multiple microagents. In other words, each microagent in a given cluster including multiple microagents may be deemed semantically proximate to those other microagents in the same cluster.

Where a group of semantically proximate microagents has been identified in the semantic hyperspace, there is a risk of agent semantic confusion due to the semantic similarities between the descriptions of these semantically proximate microagents. One or more of these semantically proximate microagents may have their descriptions updated to semantically differentiate the descriptions and reduce the likelihood of agent semantic confusion. Accordingly, the method of FIG. 7 also includes: generating 706 an updated semantic hyperspace, including: updating 708, for each of the one or more groups of microagents, the description of the corresponding service for one or more of the semantically proximate microagents using the LLM and based on inter-group communication between the plurality of semantically proximate microagents. In other words, for each cluster of microagents, the microagents therein will exchange information, thereby causing at least a subset of the included microagents to update and semantically differentiate their descriptions.

As was set forth above, each microagent may include various functions to facilitate information exchange and description modification. For example, each microagent may include an instance of a class in an object-oriented system. Such functions may include, for example, functions to read the description of another microagent, send or receive a message from another microagent, update their description, self-examine their updated descriptions, and the like. Each microagent may read the descriptions of other microagents in their cluster to determine what changes to descriptions should be requested of other microagents. Should a given microagent determine that another microagent should change its description, the given microagent may send a message describing the change to the other microagent. After all requested changes have been sent amongst microagents in a given cluster, any microagent that received such messages may summarize them and request, using an LLM, an updated description. This process for information exchange and updating descriptions may be performed for each cluster of microagents. Specific steps for updating these descriptions will be described in further detail below in subsequent flowcharts. Moreover, as will be described in further detail below, performing this process across each cluster of microagents in the semantic hyperspace may reflect a single iteration of semantic differentiation. Accordingly, in some embodiments, multiple iterations may be performed until some termination condition has been satisfied.

The resulting updated semantic hyperspace includes microagents with descriptions having been updated to semantically differentiate those microagents identified as initially having semantically similar descriptions. These updated descriptions may then be used by an LLM when selecting a particular service for use in processing prompts or requests. Readers will appreciate that these semantically differentiated descriptions improve the likelihood of the LLM selecting the most appropriate service for a particular request, improving performance of the LLM and the quality of the resulting output.

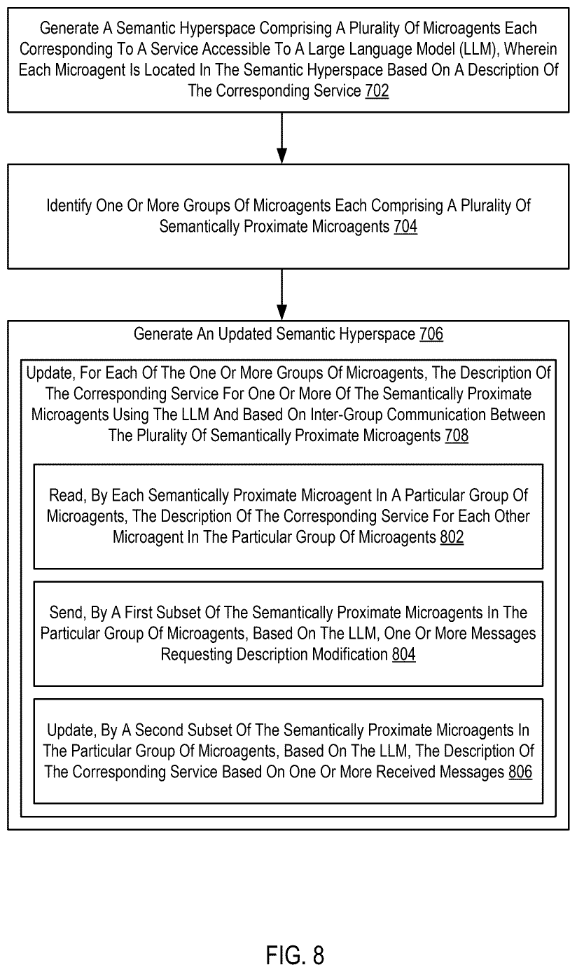

For further explanation, FIG. 8 sets forth a flowchart of another example method of autonomous semantic differentiation using machine learning in accordance with some embodiments of the present disclosure. The method of FIG. 8 is similar to FIG. 7 in that the method of FIG. 8 also includes: generating 702 a semantic hyperspace comprising a plurality of microagents each corresponding to a service accessible to a large language model (LLM), wherein each microagent is located in the semantic hyperspace based on a description of the corresponding service; identifying 704 one or more groups of microagents each comprising a plurality of semantically proximate microagents; and generating 706 an updated semantic hyperspace, including: updating 708, for each of the one or more groups of microagents, the description of the corresponding service for one or more of the semantically proximate microagents using the LLM and based on inter-group communication between the plurality of semantically proximate microagents.

The method of FIG. 8 differs from FIG. 7 in that updating 708, for each of the one or more groups of microagents, the description of the corresponding service for one or more of the semantically proximate microagents using the LLM and based on inter-group communication between the plurality of semantically proximate microagents also includes: reading 802, by each semantically proximate microagent in a particular group of microagents, the description of the corresponding service for each other microagent in the particular group of microagents. In other words, for a given cluster of microagents, each microagent will read (e.g., load or access) the description of each other microagent (e.g., of their corresponding service). Thus, each microagent will aggregate the descriptions of each other microagent to determine what description changes to request from other microagents.

The method of FIG. 8 further differs from FIG. 7 in that updating 708, for each of the one or more groups of microagents, the description of the corresponding service for one or more of the semantically proximate microagents using the LLM and based on inter-group communication between the plurality of semantically proximate microagents also includes: sending 804, by a first set of semantically proximate agents in the particular group of microagents, based on the LLM, one or more messages requesting description modification. Here, the first subset of the semantically proximate microagents are those microagents who have determined to request a description change from some other microagent in their cluster. For example, for a given microagent, that given microagent will have aggregated the descriptions of all other microagents within the same cluster. The given microagent may then determine whether to request description modification from any of those other microagents based on these aggregated descriptions.

For example, in some embodiments, the given microagent may provide, to the LLM, the description of the microagent as well as the aggregated descriptions of the other microagents within the cluster. The LLM may then provide, to the given microagent, one or more messages to be sent to other microagents requesting some change to their respective descriptions. The given microagent may then send, to each of these other microagents, a message requesting description modification as provided by the LLM. Readers will appreciate that, in some embodiments, a given microagent may not request description modification from some or potentially any of the other microagents in their respective cluster.

The method of FIG. 8 further differs from FIG. 7 in that updating 708, for each of the one or more groups of microagents, the description of the corresponding service for one or more of the semantically proximate microagents using the LLM and based on inter-group communication between the plurality of semantically proximate microagents also includes: updating 806, by a second subset of the semantically proximate microagents in the particular group of microagents, based on the LLM, the description of the corresponding service based on one or more received messages. Here, the second subset of the semantically proximate microagents are those microagents in a given cluster who have received messages requesting a description change.

For example, after each microagent in a given cluster has sent messages, if any, to other microagents requesting description changes, each microagent may then aggregate any received messages requesting description changes from them. In some embodiments, a given microagent may then provide these received messages to the LLM and request an updated description reflecting or based on the changes described in the received messages. The given microagent may then update their description (e.g., the description of their corresponding service) based on the updated description received from the LLM.

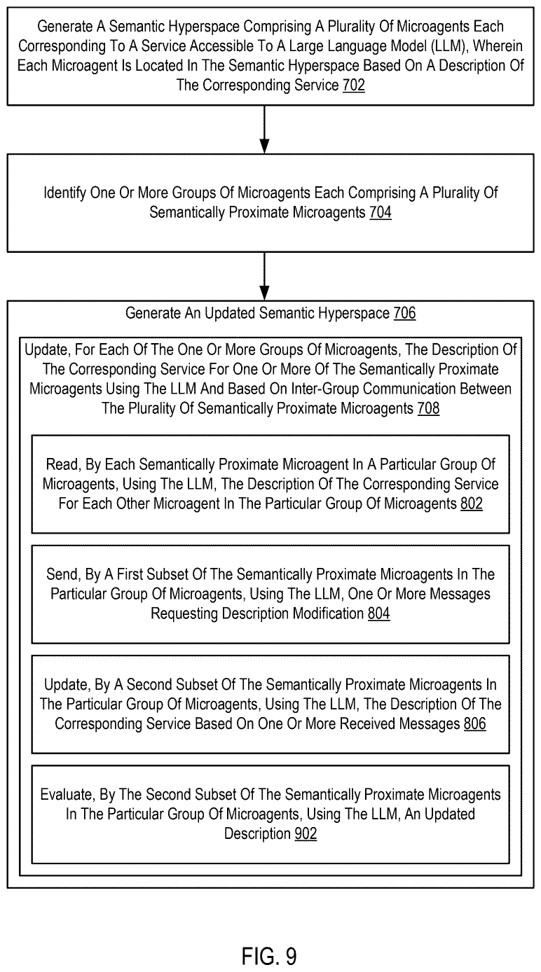

For further explanation, FIG. 9 sets forth a flowchart of another example method of autonomous semantic differentiation using machine learning in accordance with some embodiments of the present disclosure. The method of FIG. 9 is similar to FIG. 8 in that the method of FIG. 9 also includes: generating 702 a semantic hyperspace comprising a plurality of microagents each corresponding to a service accessible to a large language model (LLM), wherein each microagent is located in the semantic hyperspace based on a description of the corresponding service; identifying 704 one or more groups of microagents each comprising a plurality of semantically proximate microagents; and generating 706 an updated semantic hyperspace, including: updating 708, for each of the one or more groups of microagents, the description of the corresponding service for one or more of the semantically proximate microagents using the LLM and based on inter-group communication between the plurality of semantically proximate microagents, including: reading 802, by each semantically proximate microagent in a particular group of microagents, the description of the corresponding service for each other microagent in the particular group of microagents; sending 804, by a first set of semantically proximate agents in the particular group of microagents, based on the LLM, one or more messages requesting description modification; and updating 806, by a second subset of the semantically proximate microagents in the particular group of microagents, based on the LLM, the description of the corresponding service based on one or more received messages.

The method of FIG. 9 differs from FIG. 8 in that updating 806, by a second subset of the semantically proximate microagents in the particular group of microagents, based on the LLM, the description of the corresponding service based on one or more received messages includes evaluating 902, by the second subset of the semantically proximate microagents in the particular group of microagents, using the LLM, an updated description. In other words, after updating their descriptions, those microagents that updated their descriptions may perform a self-evaluation or examination of the updated description. In some embodiments, this may include prompting or requesting the LLM to evaluate their updated description. In some embodiments, an updated description may fail examination where it differs too much or from the previous description or fails other criteria as can be appreciated.

Where the updated description of a particular microagent fails examination, the particular microagent may request a new updated description from the LLM. In some embodiments, this request may indicate why the previous updated description failed examination so as to direct the LLM towards an updated description that passes examination. The process of examining updated descriptions and requesting new updated descriptions may repeat until an updated description passes self-examination or some other termination condition has been satisfied.

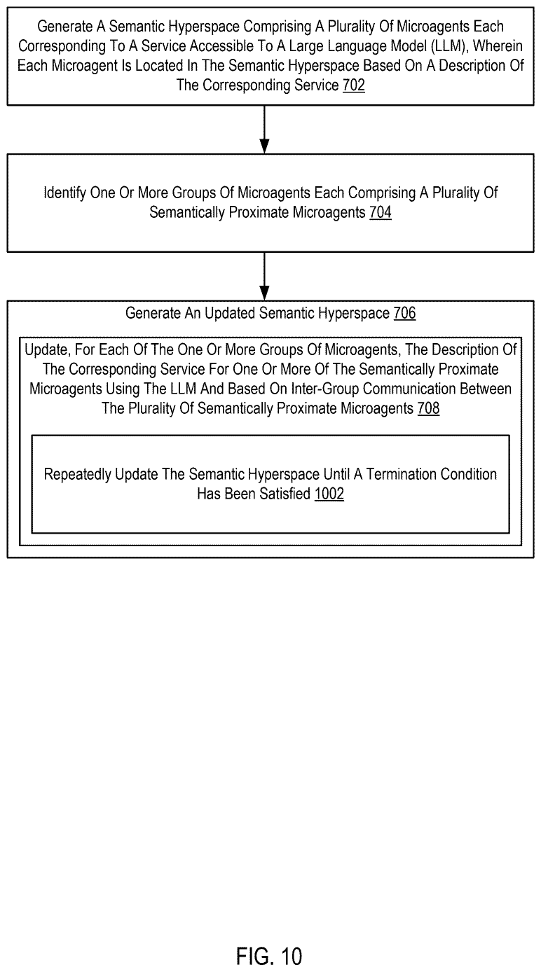

For further explanation, FIG. 10 sets forth a flowchart of another example method of autonomous semantic differentiation using machine learning in accordance with some embodiments of the present disclosure. The method of FIG. 10 is similar to FIG. 7 in that the method of FIG. 10 also includes: generating 702 a semantic hyperspace comprising a plurality of microagents each corresponding to a service accessible to a large language model (LLM), wherein each microagent is located in the semantic hyperspace based on a description of the corresponding service; identifying 704 one or more groups of microagents each comprising a plurality of semantically proximate microagents; and generating 706 an updated semantic hyperspace, including: updating 708, for each of the one or more groups of microagents, the description of the corresponding service for one or more of the semantically proximate microagents using the LLM and based on inter-group communication between the plurality of semantically proximate microagents.

The method of FIG. 10 differs from FIG. 7 in that updating 708, for each of the one or more groups of microagents, the description of the corresponding service for one or more of the semantically proximate microagents using the LLM and based on inter-group communication between the plurality of semantically proximate microagents also includes repeatedly updating 1002 the semantic hyperspace until a termination condition has been satisfied. After completing, for each cluster of multiple microagents, updates to their respective descriptions as described above, a termination condition may be evaluated. Where the termination condition has been satisfied, generating 706 the updated semantic hyperspace may be deemed completed. Where the termination condition has not been satisfied, each cluster may again perform a message exchange and update descriptions as necessary as described above. The termination condition may then be evaluated based on this iteration of updates to descriptions.

In some embodiments, the termination condition may be based on a loss function. For example, in some embodiments, the termination condition may include an output of the loss function falling below some threshold, within some margin, and the like. In some embodiments, this loss function may include a triplet loss. For example, in some embodiments, a triplet loss for an iteration of updating the semantic hyperspace may be calculated using the following formula: Triplet Loss=max(distance(f(A), f(P))−distance(f(A), f(N))+α, 0), where f(A), f(P), f(N) represent the feature representations of the anchor, positive example, and negative example, respectively, distance(·,·) denotes the distance function between feature representations, such as Euclidean distance, and α is a predefined boundary known as the margin, specifying the minimum distance between positive and negative examples.

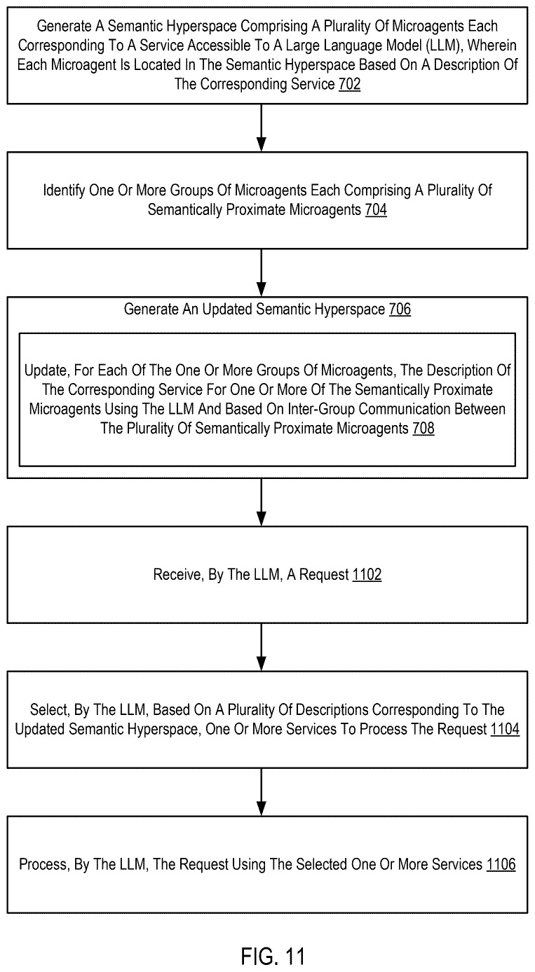

For further explanation, FIG. 11 sets forth a flowchart of another example method of autonomous semantic differentiation using machine learning in accordance with some embodiments of the present disclosure. The method of FIG. 11 is similar to FIG. 7 in that the method of FIG. 11 also includes: generating 702 a semantic hyperspace comprising a plurality of microagents each corresponding to a service accessible to a large language model (LLM), wherein each microagent is located in the semantic hyperspace based on a description of the corresponding service; identifying 704 one or more groups of microagents each comprising a plurality of semantically proximate microagents; and generating 706 an updated semantic hyperspace, including: updating 708, for each of the one or more groups of microagents, the description of the corresponding service for one or more of the semantically proximate microagents using the LLM and based on inter-group communication between the plurality of semantically proximate microagents.

The method of FIG. 11 differs from FIG. 7 in that the method of FIG. 11 also includes: receiving 1102, by the LLM, a request. The request may include, for example, a natural language expression requesting that the LLM perform some task, process some information, and the like (e.g. a prompt). The method of FIG. 11 also includes selecting 1104, by the LLM, based on a plurality of descriptions corresponding to the updated semantic hyperspace, one or more services to process the request. As is set forth above, in some embodiments, the LLM may select from multiple services that may be accessed by the LLM to service or process some request. Here, the LLM may select one or more services using the updated descriptions resulting from generating 706 the updated semantic hyperspace as described above. The method of FIG. 11 also includes processing 1106, by the LLM, the request using the selected one or more services. This may include performing one or more API calls to the one or more selected services. This may also include generating some response based on output from these API calls.

Readers will appreciate that, as the LLM used the updated descriptions to select 1104 the one or more services, the LLM is less likely to encounter agent semantic confusion due to the semantically differentiated descriptions. This improves the overall output from the LLM by selecting more appropriate or accurate services for a particular task, improving system utility and user experience.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a semantic hyperspace comprising a plurality of microagents each corresponding to a service accessible to a large language model (LLM), wherein each microagent is located in the semantic hyperspace based on a description of the corresponding service;
identifying one or more groups of microagents each comprising a plurality of semantically proximate microagents; and
generating an updated semantic hyperspace by updating, for each of the one or more groups of microagents, the description of the corresponding service for one or more of the semantically proximate microagents using the LLM and based on inter-group communication between the plurality of semantically proximate microagents.

2. The computer-implemented method of claim 1, wherein each microagent is located in the semantic hyperspace based on a vector representation of the description of the corresponding service.

3. The computer-implemented method of claim 1, wherein updating, for each of the one or more groups of microagents, the description of the corresponding service for one or more of the semantically proximate microagents comprises:
reading, by each semantically proximate microagent in a particular group of microagents, the description of the corresponding service for each other microagent in the particular group of microagents;
sending, by a first subset of the semantically proximate microagents in the particular group of microagents, based on the LLM, one or more messages requesting description modification; and
updating, by a second subset of the semantically proximate microagents in the particular group of microagents, based on the LLM, the description of the corresponding service based on one or more received messages.

4. The computer-implemented method of claim 3, further comprising evaluating, by the second subset of the semantically proximate microagents in the particular group of microagents, using the LLM, an updated description.

5. The computer-implemented method of claim 1, wherein updating, for each of the one or more groups of microagents, the description of the corresponding service for one or more of the semantically proximate microagents comprises repeatedly updating the semantic hyperspace until a termination condition has been satisfied.

6. The computer-implemented method of claim 5, wherein the termination condition comprises a loss function falling within a margin.

7. The computer-implemented method of claim 6, wherein the loss function comprises a triplet loss.

8. The computer-implemented method of claim 1, further comprising:
receiving, by the LLM, a request;
selecting, by the LLM, based on a plurality of descriptions corresponding to the updated semantic hyperspace, one or more services to process the request; and
processing, by the LLM, the request using the selected one or more services.

9. A computer system comprising:
a processor set;
one or more computer-readable storage media; and
program instructions stored on the one or more storage media to cause the processor set to perform operations comprising:
generating a semantic hyperspace comprising a plurality of microagents each corresponding to a service accessible to a large language model (LLM), wherein each microagent is located in the semantic hyperspace based on a description of the corresponding service;
identifying one or more groups of microagents each comprising a plurality of semantically proximate microagents; and
generating an updated semantic hyperspace by updating, for each of the one or more groups of microagents, the description of the corresponding service for one or more of the semantically proximate microagents using the LLM and based on inter-group communication between the plurality of semantically proximate microagents.

10. The computer system of claim 9, wherein each microagent is located in the semantic hyperspace based on a vector representation of the description of the corresponding service.

11. The computer system of claim 9, wherein updating, for each of the one or more groups of microagents, the description of the corresponding service for one or more of the semantically proximate microagents comprises:
reading, by each semantically proximate microagent in a particular group of microagents, the description of the corresponding service for each other microagent in the particular group of microagents;
sending, by a first subset of the semantically proximate microagents in the particular group of microagents, based on the LLM, one or more messages requesting description modification; and
updating, by a second subset of the semantically proximate microagents in the particular group of microagents, based on the LLM, the description of the corresponding service based on one or more received messages.

12. The computer system of claim 11, wherein the operations further comprise evaluating, by the second subset of the semantically proximate microagents in the particular group of microagents, using the LLM, an updated description.

13. The computer system of claim 9, wherein updating, for each of the one or more groups of microagents, the description of the corresponding service for one or more of the semantically proximate microagents comprises repeatedly updating the semantic hyperspace until a termination condition has been satisfied.

14. The computer system of claim 13, wherein the termination condition comprises a loss function falling within a margin.

15. The computer system of claim 4, wherein the loss function comprises a triplet loss.

16. The computer system of claim 9, wherein the operations further comprise:
receiving, by the LLM, a request;
selecting, by the LLM, based on a plurality of descriptions corresponding to the updated semantic hyperspace, one or more services to process the request; and
processing, by the LLM, the request using the selected one or more services.

17. A computer program product comprising:
one or more computer readable storage media;
program instructions stored on the one or more storage media to perform operations comprising:
generating a semantic hyperspace comprising a plurality of microagents each corresponding to a service accessible to a large language model (LLM), wherein each microagent is located in the semantic hyperspace based on a description of the corresponding service;
identifying one or more groups of microagents each comprising a plurality of semantically proximate microagents; and
generating an updated semantic hyperspace by updating, for each of the one or more groups of microagents, the description of the corresponding service for one or more of the semantically proximate microagents using the LLM and based on inter-group communication between the plurality of semantically proximate microagents.

18. The computer program product of claim 17, wherein each microagent is located in the semantic hyperspace based on a vector representation of the description of the corresponding service.

19. The computer program product of claim 18 wherein updating, for each of the one or more groups of microagents, the description of the corresponding service for one or more of the semantically proximate microagents comprises:
reading, by each semantically proximate microagent in a particular group of microagents, the description of the corresponding service for each other microagent in the particular group of microagents;
sending, by a first subset of the semantically proximate microagents in the particular group of microagents, based on the LLM, one or more messages requesting description modification; and
updating, by a second subset of the semantically proximate microagents in the particular group of microagents, based on the LLM, the description of the corresponding service based on one or more received messages.

20. The computer program product of claim 19, wherein the operations further comprise evaluating, by the second subset of the semantically proximate microagents in the particular group of microagents, using the LLM, an updated description.

21. The computer program product of claim 17, wherein updating, for each of the one or more groups of microagents, the description of the corresponding service for one or more of the semantically proximate microagents comprises repeatedly updating the semantic hyperspace until a termination condition has been satisfied.

22. The computer program product of claim 21, wherein the termination condition comprises a loss function falling within a margin.

23. The computer program product of claim 22, wherein the loss function comprises a triplet loss.

24. The computer program product of claim 17, wherein the operations further comprise:
receiving, by the LLM, a request;
selecting, by the LLM, based on a plurality of descriptions corresponding to the updated semantic hyperspace, one or more services to process the request; and
processing, by the LLM, the request using the selected one or more services.
